(19) United States
(12) Patent Application Publication
(10) Pub. No.: US 2025/0301092 A1
(43) Pub. Date: Sep. 25, 2025

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: AKIRA ISHIKAWA, Kanagawa (JP)

(21) Appl. No.: 19/080,288

(22) Filed: Mar. 14, 2025

(30) Foreign Application Priority Data
Mar. 19, 2024 (JP) 2024-044105
Jun. 11, 2024 (JP) 2024-094110

(51) Int. Cl. H04N 1/44; H04N 1/00

(52) U.S. Cl. CPC H04N 1/4433; H04N 1/00217; H04N 1/00244; H04N 1/00472; H04N 2201/0094

(57) ABSTRACT

An information processing apparatus acquires a plurality of packets that includes packets transmitted to the information processing apparatus and packets received by the information processing apparatus, performs estimation of a usage environment of the information processing apparatus by inputting data that indicates a feature of the acquired plurality of packets to a model, and displays a result of the estimation, wherein, when the number of the acquired plurality of packets is greater than or equal to a threshold value, the estimation is performed by inputting data that indicates a feature of the acquired plurality of packets to a first model, and wherein, when the number of the acquired plurality of packets is less than the threshold value, the estimation is performed by inputting data that indicates a feature of the acquired plurality of packets to a second model different from the first model.

### BACKGROUND

### Technical Field

Aspects of the present disclosure generally relate to a technique for estimating a usage environment of an information processing apparatus.

### Description of the Related Art

To implement security measures, various security-related functions included in information equipment need to be appropriately set. With regard to information equipment the usage environment of which is single and fixed, preliminarily applying, at the time of shipment thereof, setting values tailored to such a single usage environment enables the user to use, without becoming conscious of anything, information equipment for which security measures have been appropriately taken.

For example, focusing on usage environments of multifunction peripherals, the usage environments have become diversified into not only use in an office environment but also, for example, use in telework or use in a public space shared by many and unspecified persons. Since appropriate security measures differ depending on usage environments, appropriate settings meeting the respective usage environments need to be performed.

Japanese Patent Application Laid-Open No. 2019-22099 discusses a technique to create a policy by collecting operation statuses of a test network and assist updating of policies of the respective networks. Then, the technique discussed in Japanese Patent Application Laid-Open No. 2019-22099 detects the abnormality of a network by comparing feature quantities extracted from communication packets with the policy.

However, the technique discussed in Japanese Patent Application Laid-Open No. 2019-22099 still does not make the assumption that separate models or algorithms for estimation of a usage environment are selectively used based on the number of packets which are used to estimate the usage environment.

### SUMMARY

Aspects of the present disclosure are generally directed to selectively using separate models based on the number of acquired packets and appropriately estimating a usage environment of an information processing apparatus.

According to an aspect of the present disclosure, an information processing apparatus includes at least one memory that stores a program, and at least one processor that executes the program to acquire a plurality of packets that includes packets transmitted to the information processing apparatus and packets received by the information processing apparatus, perform estimation of a usage environment of the information processing apparatus by inputting data that indicates a feature of the acquired plurality of packets to a model, and display a result of the estimation, wherein, when the number of the acquired plurality of packets is greater than or equal to a threshold value, the estimation is performed by inputting data that indicates a feature of the acquired plurality of packets to a first model, and wherein, when the number of the acquired plurality of packets is less than the threshold value, the estimation is performed by inputting data that indicates a feature of the acquired plurality of packets to a second model different from the first model.

Further features of the present disclosure will become apparent from the following description of exemplary embodiments with reference to the attached drawings.

### BRIEF DESCRIPTION OF THE DRAWINGS

FIG. 1 is a block configuration diagram illustrating a connection configuration between multifunction peripherals (MFPs) and a management cloud system according to a first exemplary embodiment of the present disclosure.

FIG. 2 is an internal configuration diagram of a controller unit included in the MFP according to the first exemplary embodiment.

FIG. 3 is an internal configuration diagram of a learning server according to the first exemplary embodiment.

FIG. 4 is a block configuration diagram of software which is executed by the controller unit included in the MFP according to the first exemplary embodiment.

FIG. 5 is a block configuration diagram of software which is executed by the learning server according to the first exemplary embodiment.

FIG. 6 is a screen configuration diagram concerning security usage environment setting according to the first exemplary embodiment.

FIG. 7 is a conceptual diagram of the use of the learning model according to the first exemplary embodiment.

FIG. 8 is a conceptual diagram illustrating motions of a system using the learning model according to the first exemplary embodiment.

FIG. 9 is a flowchart illustrating processing for estimation and data transmission which the MFP performs according to the first exemplary embodiment.

FIG. 10 is a flowchart illustrating processing for data reception which the learning server performs in a learning phase according to the first exemplary embodiment.

FIGS. 11A, 11B, and 11C are screen configuration diagrams concerning security usage environment setting according to a second exemplary embodiment of the present disclosure.

FIG. 12 is a flowchart illustrating processing for estimation and data transmission which the MFP performs according to a third exemplary embodiment of the present disclosure.

### DESCRIPTION OF THE EMBODIMENTS

First, a first exemplary embodiment of the present disclosure is described based on the accompanying drawings.

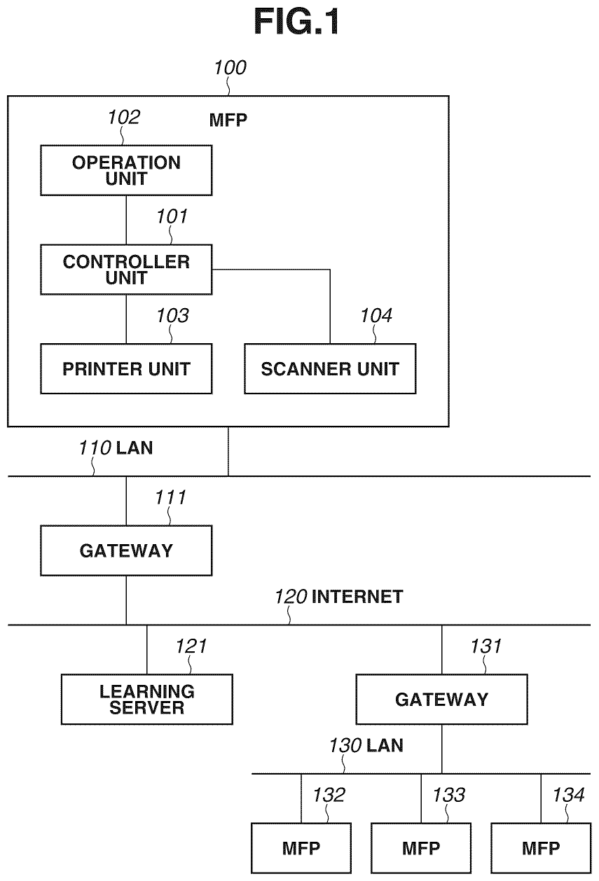

FIG. 1 is a block diagram illustrating a connection configuration between multifunction peripherals (MFPs), gateways, and a learning server according to the first exemplary embodiment. An MFP 100 and a learning server 121 are interconnected via a local area network (LAN) 110, a gateway 111, and the Internet 120. Similarly, an MFP 132, an MFP 133, an MFP 134, and the learning server 121 are interconnected via a LAN 130, a gateway 131, and the Internet 120. In the following description, the MFP 100 is described as an MFP which the user directly uses, on which the first exemplary embodiment focuses, and the MFP 132, the MFP 133, and the MFP 134 are described as MFPs which other users use somewhere. The learning server 121 is a server which an MFP vendor manages and which users for the same vendor use in common, and the MFPs 100, 132, 133, and 134 are individually managed by the respective users.

While, in the first exemplary embodiment, three MFPs, i.e., the MFP 132, the MFP 133, and the MFP 134, are illustrated for explanation, in actuality, about several million MFPs are operating around the world, and the LAN 130 and the gateway 131 are used as individual ones for each of the users.

The MFP 100 includes an operation unit 102, which is operable by the user to perform inputting and outputting. The MFP 100 further includes a printer unit 103, which outputs electronic data onto a paper medium. The MFP 100 further includes a scanner unit 104, which reads the image of a paper medium and converts the read image into electronic data. The operation unit 102, the printer unit 103, and the scanner unit 104 are connected to a controller unit 101, and implement the function of a multifunction peripheral under the control of the controller unit 101. Although not illustrated in FIG. 1 for simplicity, each of the MFPs 132, 133, and 134 also includes, as an internal configuration, the operation unit 102, the printer unit 103, and the scanner unit 104.

Each of the gateway 111 and the gateway 131 is a network router which relays a communication performed by each MFP between the MFP and the Internet 120. The learning server 121 is a server which collects pieces of information output from the MFPs and learns the tendencies of the collected pieces of information.

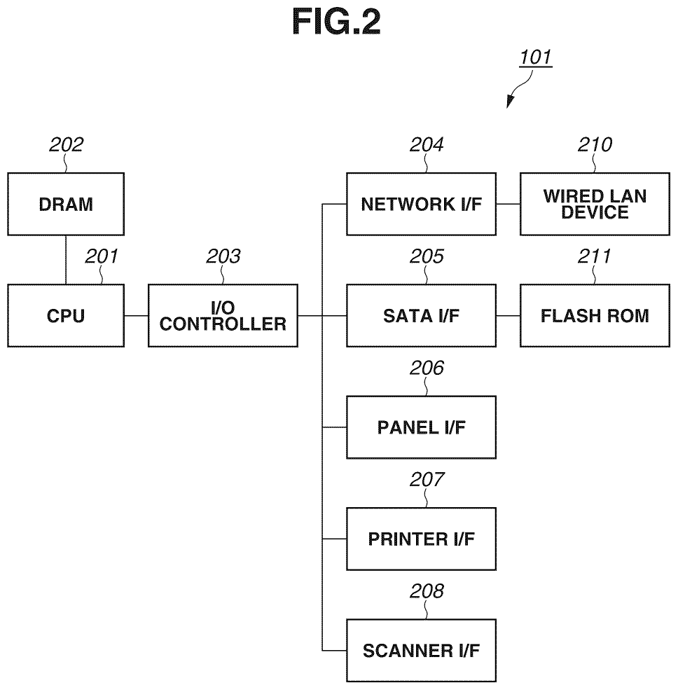

FIG. 2 is a block diagram illustrating the details of the controller unit 101 included in the MFP 100. A central processing unit (CPU) 201 performs main arithmetic processing to be performed within the controller unit 101. The CPU 201 is connected to a dynamic random access memory (DRAM) 202 via a bus. The DRAM 202 is used by the CPU 201 as a work memory for temporarily allocating program data, which represents an arithmetic operation instruction received in the process in which the CPU 201 performs an arithmetic operation, and data targeted for processing. The CPU 201 is also connected to an input-output (I/O) controller 203 via a bus.

The I/O controller 203 performs inputting from and outputting to various devices according to instructions from the CPU 201. A Serial Advanced Technology Attachment (SATA) interface (I/F) 205 is connected to the I/O controller 203, and a flash read-only memory (ROM) 211 is connected to the SATA I/F 205. The CPU 201 uses the flash ROM 211 to permanently store programs, which are used to implement the functions of an MFP, and document files. A network I/F 204 is connected to the I/O controller 203. A wired LAN device 210 is connected to the network I/F 204. The CPU 201 controls the wired LAN device 210 via the network I/F 204, thus implementing communications on the LAN 110. A panel I/F 206 is connected to the I/O controller 203, and the CPU 201 implements inputting to and outputting from the operation unit 102 for the user via the panel I/F 206. A printer I/F 207 is connected to the I/O controller 203, and the CPU 201 implements output processing on a paper medium using the printer unit 103 via the printer I/F 207.

For example, to perform a copy function, the CPU 201 reads program data from the flash ROM 211 into the DRAM 202 via the SATA I/F 205. The CPU 201 detects a copy instruction from the user to the operation unit 102 via the panel I/F 206 according to the program read into the DRAM 202. Upon detecting the copy instruction, the CPU 201 receives an original as electronic data from the scanner unit 104 via a scanner I/F 208, and then stores the electronic data in the DRAM 202. The CPU 201 performs, for example, color conversion processing adapted for outputting on the image data stored in the DRAM 202. The CPU 201 transfers the image data stored in the DRAM 202 to the printer unit 103 via the printer I/F 207, and thus performs output processing onto a paper medium.

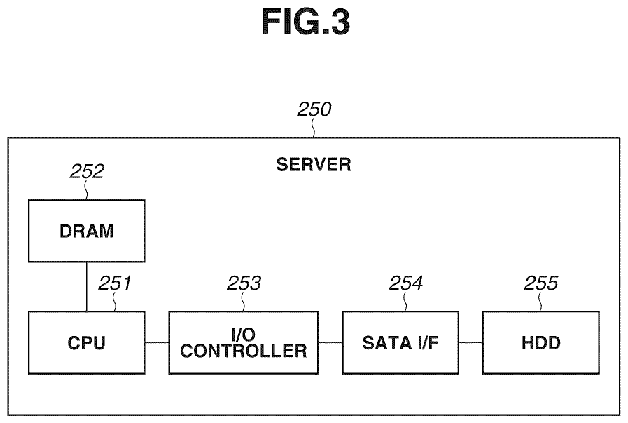

FIG. 3 is a block diagram illustrating the details of a server 250, which implements the learning server 121. A CPU 251 performs main arithmetic processing to be performed within the server 250. The CPU 251 is connected to a DRAM 252 via a bus. The DRAM 252 is used by the CPU 251 as a work memory for temporarily allocating program data, which represents an arithmetic operation instruction received in the process in which the CPU 251 performs an arithmetic operation, and data targeted for processing. The CPU 251 is also connected to an I/O controller 253 via a bus.

The I/O controller 253 performs inputting from and outputting to various devices according to instructions from the CPU 251. A Serial Advanced Technology Attachment (SATA) interface (I/F) 254 is connected to the I/O controller 253, and a hard disk drive (HDD) 255 is connected to the SATA I/F 254. The CPU 251 uses the HDD 255 to permanently store programs, which are used to implement various server functions, and setting values. In this way, pieces of hardware including, for example, the CPU 251, the DRAM 252, and the HDD 255 constitute what is called a computer. While, in the first exemplary embodiment, for explanation's sake, a case where one CPU 251 uses one memory (DRAM 252) to perform processing operations illustrated in a flowchart described below is illustrated as an example, another configuration can be employed. For example, a plurality of processors, a RAM, a ROM, and a storage can also be configured to cooperate with each other to perform processing operations illustrated in a flowchart described below. Moreover, a plurality of server computers can also be used to perform the processing operations. The server 250 uses containerization or virtualization techniques and is thus able to provide a management cloud system (learning server 121) to a plurality of different tenants.

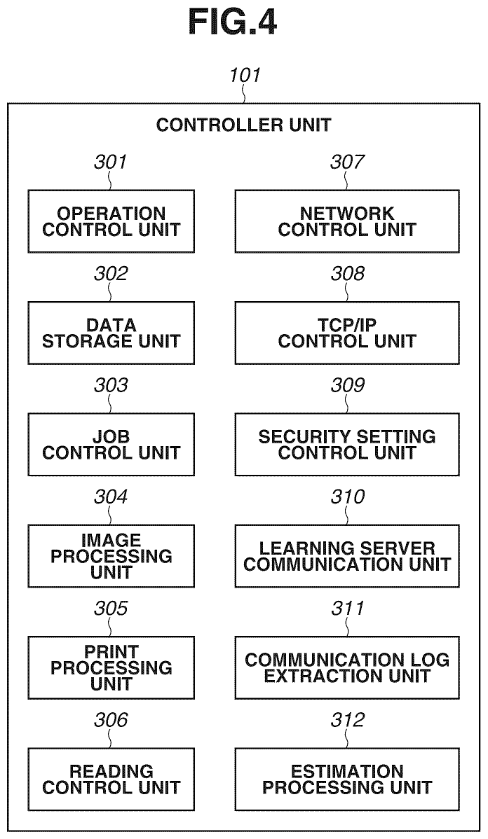

FIG. 4 is a block diagram illustrating a structure of software which is executed by the controller unit 101 included in the MFP 100. All of the pieces of software, which the controller unit 101 executes, are executed after the CPU 201 reads a program stored in the flash ROM 211 into the DRAM 202.

An operation control unit 301 performs, on the operation unit 102, displaying of a screen image directed to the user, detection of a user operation thereon, and processing associated with a screen component such as a button displayed on the screen. A data storage unit 302 performs storing of data into the flash ROM 211 and read-out of the data therefrom in response to a request received from another control unit. For example, in a case where the user has wanted to change some device settings, the operation control unit 301 detects a content which the user has input to the operation unit 102, and the data storage unit 302 stores the detected content as setting values into the flash ROM 211 in response to a request received from the operation control unit 301. A job control unit 303 performs control of job execution according to an instruction from another control unit. An image processing unit 304 processes image data into a form adapted for each use application according to an instruction received from the job control unit 303. A print processing unit 305 prints an image on a paper medium via the printer I/F 207 and outputs the printed paper medium, according to an instruction from the job control unit 303. A reading control unit 306 reads a placed original via the scanner I/F 208 according to an instruction received from the job control unit 303.

A network control unit 307 performs network setting for, for example, Internet Protocol (IP) addresses on a Transmission Control Protocol/Internet Protocol (TCP/IP) control unit 308 at the time of system start-up or at the time of setting change detection according to setting values stored in the data storage unit 302. The TCP/IP control unit 308 performs transmission and reception processing of network packets via the network I/F 204 according to an instruction received from another control unit. Network packets which the network control unit 307 transmits and receives via the network I/F 204 include packets concerning jobs which are executed in the printer unit 103 and the scanner unit 104.

A security setting control unit 309 manages correspondence relationships between usage environments, such as an in-house LAN, telework, and public space, and security-related setting items for the respective usage environments, and thus is able to collectively set the corresponding security-related settings in response to the user having designated a usage environment. The security setting control unit 309 uses the data storage unit 302 to refer to and change the setting values. The security setting control unit 309 sets, to the MFP 100, a setting value corresponding to the usage environment which the user has selected via the operation unit 102. For example, the operation control unit 301 displays, on the operation unit 102, a result obtained by an estimation processing unit 312 having performed estimation, and the user checks the displayed result and then selects a usage environment corresponding to the result of estimation. Moreover, the security setting control unit 309 can automatically set, to the MFP 100, a setting value corresponding to a usage environment which is obtained as a result obtained by the estimation processing unit 312 having performed estimation, without any user operation.

A learning server communication unit 310 uses the network control unit 307 to perform delivery and receipt of information between the learning server 121 and the MFP 100. The learning server communication unit 310 transmits communication data which a communication log extraction unit 311 has extracted to the learning server 121.

The communication log extraction unit 311 uses the network control unit 307 to extract communication logs which the MFP 100 transmits and receives. The communication log extraction unit 311 performs extraction processing to extract IP addresses, types of Transmission Control Protocol/User Datagram Protocol (TCP/UDP), port numbers, and IP header information about a destination and a transmission source out of pieces of information accompanied by network packets. This extraction processing excludes a content portion of each packet which is called a payload.

The estimation processing unit 312 performs estimation processing at the time of screen displaying or in response to initialization of the network function.

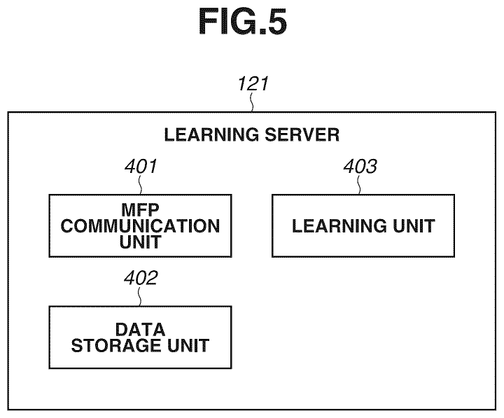

FIG. 5 is a block diagram illustrating a structure of software which is executed by the learning server 121.

All of the pieces of software, which the learning server 121 executes, are executed after the CPU 251 reads a program stored in the HDD 255 into the DRAM 252.

An MFP communication unit 401 controls communications which are performed between the MFP 100 and the learning server 121, and stores pieces of information, such as a communication log and a usage environment, received from the MFP 100 in a data storage unit 402.

The data storage unit 402 performs storing and reading-out of data in and from a distributed resource on cloud computing in response to a request received from another control unit.

A learning unit 403 generates, as a learning model, a tendency of communication logs relative to usage environments based on associations between communication logs and usage environments stored in the data storage unit 402. The learning unit 403 then stores the generated learning model in the data storage unit 402.

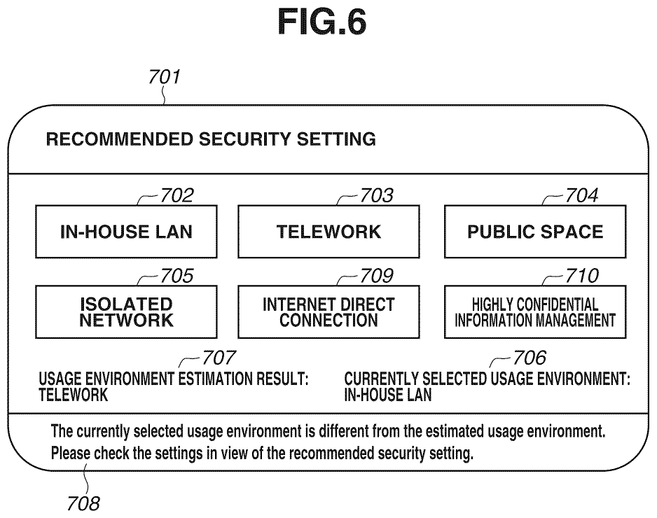

FIG. 6 illustrates a recommended security setting screen 701, which is displayed on the operation unit 102. A usage environment in-house LAN button 702 is a button operable to collectively set a series of security settings which are deemed to be appropriate in a case where the usage environment is an in-house LAN. A usage environment telework button 703 is a button operable to collectively set a series of security settings which are deemed to be appropriate in a case where the usage environment is telework. A usage environment public space button 704 is a button operable to collectively set a series of security settings which are deemed to be appropriate in a case where the usage environment is a public space. An isolated network button 705 is a button operable to collectively set a series of security settings which are deemed to be appropriate in a case where the usage environment is an isolated network. An Internet direct connection button 709 is a button operable to collectively set a series of security settings which are deemed to be appropriate in a case where the usage environment is Internet direct connection. A highly confidential information management button 710 is a button operable to collectively set a series of security settings which are deemed to be appropriate in a case where the usage environment is highly confidential information management. Upon detecting that the user has selected one usage environment in the recommended security setting screen 701, the security setting control unit 309 sets, to the MFP 100, setting values corresponding to the selected usage environment. Specifically, the security setting control unit 309 collectively sets, to the MFP 100, a plurality of setting values which are recommended for the selected usage environment.

A currently selected usage environment indication 706 displays a usage environment which has been set by operating one of the buttons 702, 703, 704, 705, 709, and 710. Information indicating which pattern has been selected as the set usage environment is currently stored in the data storage unit 302 together with date and time information indicating when the button was pressed at the timing when the corresponding button has been pressed. A usage environment estimation result 707 displays a usage environment which has been estimated by estimation processing from a tendency of communication data.

An information display portion 708 is a region for notifying the user of various pieces of information. In the display example illustrated in FIG. 6, since there is a high possibility that the user's selection is not appropriate, the information display portion 708 prompts the user to readjust the setting in view of the recommended security setting screen 701.

While, here, for example, usage environments have been described based on usage scenes, such as telework, a configuration in which several variations in intensity, such as security level 1 and security level 2, are simply prepared can be employed. In that case, while learning of communication logs and estimation are performed with respect to the security intensity, since the security intensity is essentially associated with usage scenes, the same thing is essentially performed.

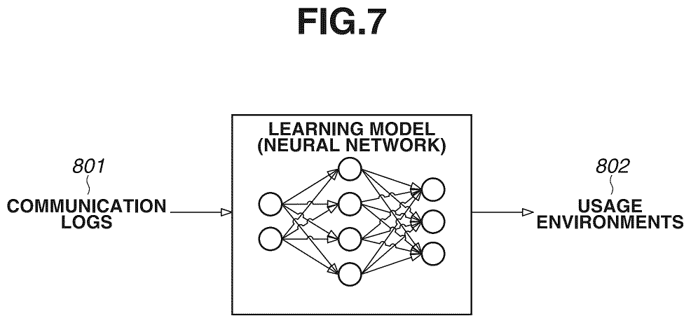

FIG. 7 is a conceptual diagram illustrating a structure of inputting and outputting using a learning model in the first exemplary embodiment. In estimation processing, the learning model receives, as an input, communication logs 801 and outputs usage environments 802.

Specifically, the usage environments 802 are configured with patterns shown in Table 1.

TABLE 1

| Usage Environment | Brief Summary |
|---|---|
| In-house LAN | General office environment |
| Isolated network | Network prohibited from connecting |
| | to the Internet and thus isolated |
| | therefrom |
| Telework | Home network on the assumption of telework time |
| Public space | Open space in which many and |
| | unspecified persons move in and out and |
| | share a network |
| Internet direct | Environment for directly connecting |
| connection | to the Internet without any local |
| | area network present in an office |
| Highly confidential | Environment for, to protect highly |
| information | confidential information, imposing |
| management | severe restrictions on communications |
| | even if decreasing convenience |

The in-house LAN targets an environment which is a general office environment and in which many people gather together and Internet connection is also being performed to use some cloud services. The number of pieces of information equipment which connect to the in-house LAN is the largest among those of the other usage environments. In the case of such an environment, usually, a controlled firewall is provided at a boundary between the in-house LAN and an external network, and persons entering the room are limited to only employees.

Security measures which are taken on the usage environment side and security measures which are taken by each terminal are used in a balanced manner.

The isolated network targets an environment which is used with a network in which the connection to the Internet is cut off as an Internet topology due to circumstances such as using an old-type protocol for some reason and which is thus isolated. The number of pieces of information equipment which connect to the isolated network is relatively small. Strongly taking security measures on the usage environment side enables lowering the required level of security measures which are to be taken on each terminal side.

The telework targets an environment in which a small-sized LAN for use in home, which is a home network targeting the time of telework, is being directly used for a telework operation. The number of pieces of information equipment which connect to the telework is the smallest. On the assumption that security measures which are taken on the usage environment side are not so much reliable, it is necessary to take security measures on the terminal side in a balanced manner.

The public space targets an open space in which many and unspecified persons move in and out and share a network. An airport lounge or a coworking space available for guest usage fall into the public space, and the public space is assumed to be used under unexacting entry restrictions. The number of pieces of information equipment which connect to the public space is relatively large. Security measures which are taken on the usage environment side are basically not reliable, and it is necessary to take security measures on the terminal side even at the cost of functionality to some extent.

The Internet direct connection targets an environment which does not include any local area network within an office and which directly connects to the Internet. Since, for example, firewall protection on the network side is not expected, it is necessary to take security measures against unauthorized access on the terminal side.

The highly confidential information management targets an environment in which, since highly confidential information such as customer personal information is handled on the terminal side, security is increased to the maximum even at the cost of user's convenience. In such an environment, while, on the network side, link encryption using Internet Protocol Security (IPsec) is often performed, besides this, it is also necessary to take as safe security measures as possible on the terminal side.

The communication logs 801 are specifically configured with pieces of data shown in Table 2. One piece of communication log data is generated from an input packet which is composed of a plurality of network packets.

TABLE 2

| Communication Log Attribute | Brief Summary |
|---|---|
| Number of destination | Proportional to the number |
| addresses | of external services which |
| | equipment uses |
| Number of transmission source | Proportional to the number |
| addresses | of pieces of equipment forming |
| | a network |
| Number of types of | Proportional to the tendency |
| usable protocols | of usage of equipment |
| Variations of TTL attributes | Corresponding to a distance |
| of IP headers | between terminals forming a |
| | network |
| Packet with global IP address | Corresponding to a network |
| being included | being accessible from an |
| | external unit |
| Packet of IPSec | Corresponding to link encryption |
| communication being | in low layer being applied |
| included | to a network |

The number of destination addresses is the number of variations of addresses which communication packets included in input packets have designated as destinations. If equipment uses various external services, this value becomes large. If this value is extremely small, the possibility that the usage environment is an isolated network, in which communications are restricted, is relatively high.

The number of transmission source addresses is the number of variations of protocols which communication packets included in input packets have designated as transmission sources. If a large number of information apparatuses are present within a network, this value becomes large. While there is a tendency similar to a traffic amount, since values which are looked at are essentially different ones, combining the values to look at the tendency enables more increasing the estimation accuracy.

The number of types of usable protocols is the number of variations of protocols which communication packets included in input packets have been using. If the number of pieces of information equipment which connect to a network is larger, the number of types of usable protocols becomes larger in proportion thereto. Moreover, in the case of a network environment with strong function restriction, the number of types of usable protocols becomes a small value. If this value is small, it is highly likely that the usage environment is an isolated network or a public space.

The number of Time to Live (TTL) values of IP headers is the number of variations of TTL values accompanying communication packets included in input packets. Since the TTL value is a value which is decremented each time the TTL value passes through a router, in the case of a packet which has arrived after passing through many routers, the number of TTL values of IP headers becomes a small value.

An environment in which the number of TTL values of IP headers has only large values with uniformity is highly likely to be a small-sized network, and an environment in which the number of TTL values of IP headers has variations from large values to small values is highly likely to be a large-sized network.

The attribute indicative of a packet with a global IP address being included is a value which is set to “1” in a case where a global IP address is included in a transmission source address of the input packet and to “0” in a case where no global IP address is included therein. In a case where a global IP address is included therein, it is found that the network is accessible from an external unit. While, in such a case, the usage environment is highly likely to be Internet direct connection, even in a case where a global IP address is included therein, the usage environment may be another environment, and, even in a case where no global IP address is included therein, the usage environment may be Internet direct connection. Here, the global IP address is an IP address included in those shown in Table 3.

TABLE 3

```
        1.0.0.0-9.255.255.255
      11.0.0.0-126.255.255.255
    128.0.0.0-172.15.255.255
  172.32.0.0-191.255.255.255
    192.0.0.0-192.167.255.255
192.169.0.0-223.255.255.255
```

The attribute indicative of a packet of IPSec communication being included is a value which is set to “1” in a case where IPSec communication is included in the input packet and to “0” in a case where IPSec communication is not included therein. In a case where IPSec communication is included therein, it is found that link encryption in a low layer is being applied to the network. While, in such a case, the usage environment is highly likely to be an environment for highly confidential information management, even in a case where IPSec communication is included therein, the usage environment may be another environment, and, even in a case where IPSec communication is not included therein, the usage environment may be environment for highly confidential information management.

As seen above, while each of various parameters has a certain degree of tendency with respect to features such as network scales, it is difficult to logically determine a threshold value for determining such a tendency, and, moreover, estimation is performed by combining a plurality of parameters and multiply performing determination. For this reason, in the first exemplary embodiment, with use of a learning algorithm, estimation processing is performed based on a combination of a usage environment and communication logs which have been obtained therein. Since repeating a number of experiments also enables determining a threshold value without use of a learning program, the present technique is a technique which can be applied to even such a method that is based on a threshold value not using a learning algorithm.

Communication logs serving as inputs are individually subjected to processing and converted into respective numerical vectors, so that the accuracy of estimation can be increased.

With regard to variations of TTL attributes, the numbers of packets included in respective input packets are formed into a histogram, threshold values for sectionalizing, for example, an equivalent amount of data to five ranges are determined, and integers of 1 to 5, which are values of the corresponding ranges, are used as inputs.

With regard to the number of destination addresses, the number of transmission sources, and the number of types of protocols, appearance variations with unique values included in input packets are used. Specifically, the number of packets having the same value included in input packets in duplicate manner is counted, packets corresponding to the respective numbers of duplicates are selected in order from the largest value of the number of duplicates, and, at the time point when 1% of all of the packets has been selected, the number of selected values is used. Since, although depending on how to take a unit time, the value falls within the range of about 1 to 20, this value is used. If a value which greatly exceeds 20 appears sporadically, for example, processing for rounding this value to 20 can be performed.

Usually, in a case where parameters which greatly differ in value range are input to a learning algorithm, the difference between value ranges may affect the estimation accuracy. For example, in a case where only variations of TTLs are within the value range of 1 to 10,000 and the others are within the value range of 1 to 10, an estimation result which reacts strongly to variations of TTLs may be obtained. To use the respective parameters in a balanced manner, performing such numerical vectorization enables increasing the estimation accuracy.

In the learning phase, a large number of communication logs 801 are used to generate one learning model. At this time, the numbers of packets included in the respective input packets, which serve as generation sources of the respective communication logs 801, need to be identical with each other. This is because, even with respect to communication logs acquired in exactly the same environment, if the number of included packets is 1, there is only one destination address and, if the number of included packets is 100, the value of the number of destination addresses may be about 20, which is unsuitable as data for estimating an environment. In the first exemplary embodiment, a learning model for a first threshold value uses an input packet in which 150 packets are included, and a learning model for a second threshold value uses an input packet in which 50 packets are included. This also applies to communication logs which are input in the estimation phase, and an input packet to be used therefor needs to be an input packet in which packets the number of which is the same as that needed at the time of learning are included. While a method in which, in a case where only 50 packets have been able to be taken in the estimation phase, a learning model which has trained with an input packet in which 150 packets, obtained by triplicating the taken 50 packets, are included is used is also conceivable, this approach may cause a drastic decrease in estimation accuracy. For example, with respect to an environment in which, when 150 packets are acquired, the number of destination addresses becomes 20, even in a case where only 50 packets have been acquired, destination addresses the number of which is close to 20 can also be often taken. This is because, to count the number of unique values, as the number of acquired packets increases, the increase in value becomes slower. If, in this case, triplication is performed, the value becomes 60, so that estimation may be performed as an entirely different environment. While, as a preparatory method for learning data for 50 packets, samples for 50 packets can be extracted from samples for acquired 150 packets, it is favorable to use data obtained in an environment in which only 50 packets have been able to be acquired.

A learning model is able to be generated by collecting, in an actual environment, a large number of samples for combinations of communication logs 801 serving as inputs and usage environments 802 corresponding to outputs and performing learning based on the collected samples. In the first exemplary embodiment, an array of parameters of communication logs is set as a one-dimensional array, and a two-dimensional array is formed by sampling the one-dimensional array a plurality of times and sequencing the sampled parameters in a time-series manner. Then, a learning model is generated with use of a general algorithm for generating a convolutional neural network model. Furthermore, a classifier can be configured with use of an algorithm such as the k-nearest neighbors algorithm (k-NN) or support vector machines (SVMs).

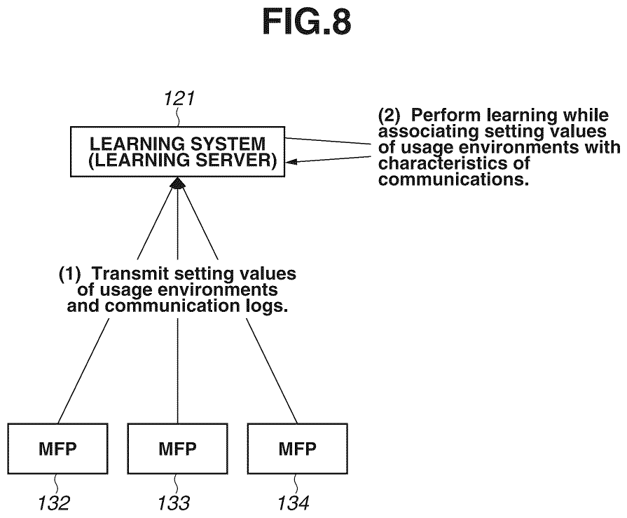

FIG. 8 is a diagram used to explain an operation of the system in a learning phase, to which the present disclosure is applicable, using the structure of the learning model illustrated in FIG. 7. MFPs 132, 133, and 134 are steadily transmitting, to the learning system (learning server) 121, patterns of usage environments shown in Table 1 set to respective pieces of equipment via the recommended security setting screen 701 and communication logs including pieces of information shown in Table 2 which the communication log extraction unit 311 has extracted. While, in the first exemplary embodiment, only three MFPs are illustrated for the sake of explanation, actually, the learning system (learning server) 121 collects pieces of data about millions of pieces of equipment which are being operated in the world. The thus-obtained combinations of usage environments and communication logs are subjected to numerical vectorization explained with reference to FIG. 7 and are then calculated with a machine learning algorithm, so that a learning model is generated. Since, actually, pieces of data which are obtained in the respective usage environments may be biased, the numbers of samples of the respective pieces of data are arranged in such manner that overlearning does not occur with respect to a specific usage environment, or processing of data such as removing, for example, data becoming an outlier based on a standard deviation is performed for each usage environment.

Performing estimation using a learning model generated as a result of a series of operations illustrated in FIG. 8 enables presenting usage environment setting which is highly likely to be appropriate for being set to an MFP which the user uses, based on usage environment settings and communication logs of MFPs also including those other than the MFP which the user uses.

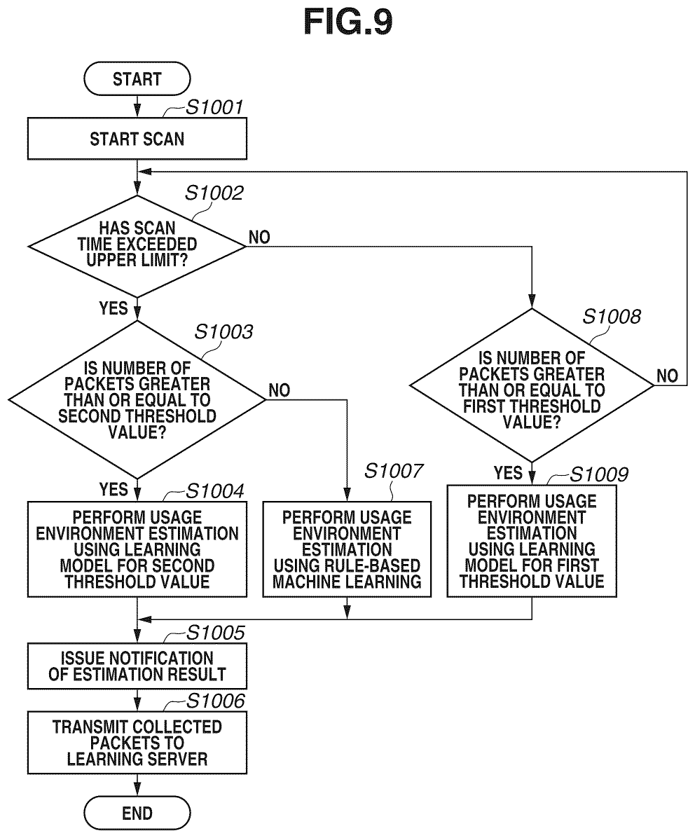

Processing which the MFP 100 performs to perform estimation processing, notify the user of a result of the estimation processing, and perform information transmission to a learning server directed to a future accuracy increase is described with reference to FIG. 9. The processing which the MFP 100 performs illustrated in FIG. 9 includes processing operations which are performed by the communication log extraction unit 311, the estimation processing unit 312, the operation control unit 301, and the learning server communication unit 310. The processing which the MFP 100 performs illustrated in FIG. 9 is implemented, as arithmetic processing which the CPU 201 performs, by the CPU 201 reading out a program stored in the flash ROM 211 onto the DRAM 202 and executing the program.

The processing in the flowchart of FIG. 9 is started at the time of completion of initialization of the network function or at the time of displaying of the recommended security setting screen 701 in the MFP 100. The initialization of the network function is performed, for example, at the time of system start-up after powering-on of equipment or at the time of changing of the network setting and is timing at which the MFP 100 becomes able to perform communication.

In step S1001, the MFP 100 starts scan. Specifically, the communication log extraction unit 311 captures network packets which are transmitted and received between the MFP 100 and the LAN 110.

In step S1002, the communication log extraction unit 311 checks whether the scan time has exceeded an upper limit thereof. Thus, the communication log extraction unit 311 checks whether a predetermined time has elapsed after starting scan of network packets. In the first exemplary embodiment, the upper limit of the scan time is assumed to be 60 seconds. This is preliminarily determined as a time for which network packets corresponding to a first threshold value, which is checked in step S1008, are able to be collected in many network environments. If it is determined that the scan time has exceeded the upper limit (YES in step S1002), the communication log extraction unit 311 advances the processing to step S1003, and, if it is determined that the scan time has not yet exceeded the upper limit (NO in step S1002), the communication log extraction unit 311 advances the processing to step S1008.

In step S1008, the communication log extraction unit 311 checks whether the number of packets is greater than or equal to the first threshold value.

Thus, the communication log extraction unit 311 checks whether the number of packets acquired within a predetermined time from the start of scan of network packets is greater than or equal to the first threshold value. In the first exemplary embodiment, the first threshold value is assumed to be 150 packets. This is preliminarily determined by verifying improved characteristics of the estimation accuracy relative to an increase in the number of input packets with respect to a usage environment estimation model and finding a branch point at which the proportion of an accuracy increase to an increase in the number of packets slows down. While, in terms of the estimation accuracy, it is favorable that the number of packets supposed to be inputs is greater, in terms of the estimation result displaying function, it is favorable that the scan time which depends on the number of packets is smaller. Moreover, it is known that, usually, the rate of progress of the estimation accuracy to the number of pieces of data supposed to be inputs becomes a logarithmic increase graph which slows down along with an increase in the number of pieces of data. If it is determined that the number of acquired packets is greater than or equal to the first threshold value (YES in step S1008), the communication log extraction unit 311 advances the processing to step S1009. If it is determined that the number of acquired packets is neither greater than nor equal to the first threshold value, i.e., is less than the first threshold value (NO in step S1008), the communication log extraction unit 311 returns the processing to step S1002. In a case where the number of acquired packets is neither greater than or equal to the first threshold value, a small amount of processing stop time can be provided to avoid an excessive repetitive arithmetic operation.

In step S1009, the estimation processing unit 312 performs usage environment estimation using a learning model for the first threshold value. While the first threshold value is assumed to be 150 packets, the learning model for the first threshold value is a learning model for which data with 150 packets is prepared as each of data sets usable as learning data at the time of learning and which is optimized for inputting of 150 packets. Since this step is performed only in a case where 150 packets have been able to be acquired, these acquired packets are used as inputs for the estimation processing. Specifically, the estimation processing unit 312 extracts feature quantities such as those shown in Table 2 with use of 150 packets out of the packets which the communication log extraction unit 311 has been able to acquire within the predetermined time. The estimation processing unit 312 inputs the feature quantities which the communication log extraction unit 311 has extracted to the learning model for the first threshold value, and thus estimates a usage environment.

In step S1003, the communication log extraction unit 311 checks whether the number of packets is greater than or equal to a second threshold value.

In the first exemplary embodiment, the second threshold value is assumed to be 50 packets. This is preliminarily determined by verifying improved characteristics of the estimation accuracy relative to an increase in the number of input packets with respect to a usage environment estimation model and finding a lower limit value available for obtaining a significant estimation result. If it is determined that the number of acquired packets is greater than or equal to the second threshold value (YES in step S1003), the communication log extraction unit 311 advances the processing to step S1004. If it is determined that the number of acquired packets is neither greater than nor equal to the second threshold value, i.e., is less than the second threshold value (NO in step S1003), the communication log extraction unit 311 advances the processing to step S1007.

In step S1004, the estimation processing unit 312 performs usage environment estimation using a learning model for the second threshold value. While the second threshold value is assumed to be 50 packets, the learning model for the second threshold value is a learning model for which data with 50 packets is prepared as each of data sets usable as learning data at the time of learning and which is optimized for inputting of 50 packets. While there is a case where, in this step, 51 or more packets are acquired, only 50 packets in the order of being received are used as inputs for estimation processing. Specifically, the communication log extraction unit 311 extracts feature quantities such as those shown in Table 2 with use of 50 packets out of the packets which the communication log extraction unit 311 has been able to acquire within the predetermined time. The estimation processing unit 312 inputs the feature quantities which the communication log extraction unit 311 has extracted to the learning model for the second threshold value, and thus estimates a usage environment.

In step S1007, the estimation processing unit 312 performs usage environment estimation using rule-based machine learning. The estimation using rule-based machine learning is, for example, an estimation such as mentioned below. If an IPSec packet is included, the usage environment is uniformly estimated as a highly confidential information management environment. If a global IP address packet is included, the usage environment is uniformly estimated as an Internet direct connection environment. If such conditions are not met, the usage environment is estimated as an in-house intranet environment. The estimation using rule-based machine learning is such a decision table-based estimation. While this is lower in accuracy than the case using a learning model, there are many cases where this is better than the situation in which an estimation result is not able to be output due to the nature of the function.

In step S1005, the MFP 100 issues a notification of the estimation result. Specifically, the operation control unit 301 issues a notification of the estimation result. When being displaying the recommended security setting screen 701, the operation control unit 301 displays a usage environment estimated in any one of step S1004, step S1007, and step S1009 at the usage environment estimation result 707. At this timing, the operation control unit 301 can transmit the estimation result to a management tool to display the estimation result on a display unit of the management tool, or can record the estimation result as a log in the MFP 100.

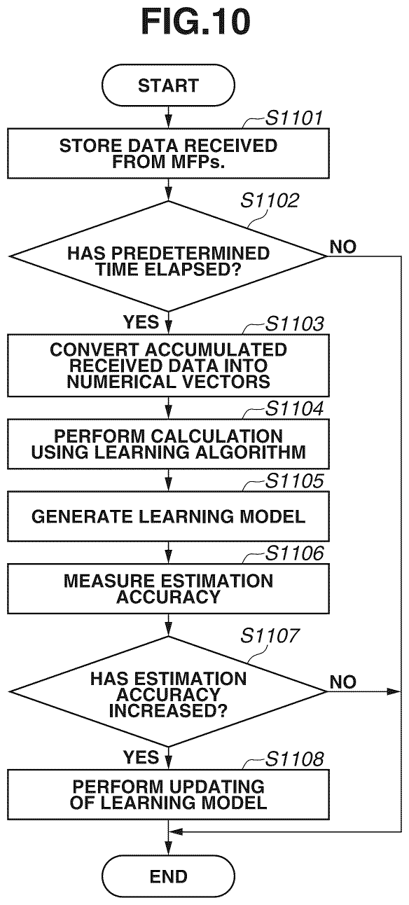

In step S1006, the MFP 100 transmits the collected packets to the learning server 121. Specifically, the learning server communication unit 310 transmits the collected packets to the learning server 121. Processing which the learning server 121 performs after receiving such data is described with reference to FIG. 10.

The processing in the above-described flowchart enables performing usage environment estimation using a learning model which is appropriate depending on the largeness or smallness of a communication volume.

Processing which the learning server 121 performs after receiving learning data and until performing updating of a learning model is described with reference to FIG. 10. In the first exemplary embodiment, all of the pieces of software which are executed by the learning server 121 illustrated in FIG. 10 are implemented by the CPU 251 reading out a program stored in the HDD 255 onto the DRAM 252 and executing the program.

The processing in the present flowchart is started after the learning server 121 receives communication logs from the MFP 132, 133, and 134.

In step S1101, the learning server 121 stores data received from the MFPs.

In a case where the usage environment is an isolated network mentioned with reference to Table 1, it is impossible to perform data collection via the Internet, so that some kind of ingenuity is necessary. For example, establishing virtual private network (VPN) connection between the user's network and the learning server 121 enables performing connection without via the Internet. Moreover, at the time of visiting the user, a service engineer can copy logs accumulated in the MFP 100 onto a portable storage medium and, after that, transmit the copied logs to the learning server 121.

This is processing for receiving data which the MFP 100 has transmitted in step S1006 and storing the received data in the data storage unit 402.

In step S1102, the learning server 121 checks whether a predetermined time has elapsed. For example, in the case of updating a learning model with a predetermined period such as once a week, the learning server 121 checks whether data collection has been performed for a week. If it is determined that the predetermined time has elapsed (YES in step S1102), the learning server 121 advances the processing to step S1103, and, if it is not determined that the predetermined time has elapsed (NO in step S1102), the learning server 121 ends the processing in the present flowchart. While, in the first exemplary embodiment, a time is set as a condition for determination, the data volume such as the number of received communication logs being 10,000 can be set as a condition for determination.

In step S1103, the learning server 121 converts the accumulated received data into numerical vectors. Specifically, the learning server 121 performs numerical vectorization processing to be performed on communication logs serving as inputs described above with reference to FIG. 7, thus converting the received communication logs into arrays of integers matching in value range. The learning server 121 arranges these communication logs, which are one-dimensional arrays, side by side in time-series manner for each individual MFP, thus obtaining two-dimensional arrays. The learning server 121 uses these two-dimensional arrays as input data, and uses these patterns of usage environments set for the respective individual MFPs as training data, thus forming one piece of learning data. The learning server 121 performs similar processing operations on pieces of data about all of the MFPs, thus obtaining a learning data set. Furthermore, to generate a learning model for the first threshold value, the learning server 121 uses data about packets the number of which is the number indicated by the first threshold value, to create training data. To generate a learning model for the second threshold value, the learning server 121 uses data about packets the number of which is the number indicated by the second threshold value, to create training data.

In step S1104, the learning server 121 performs calculation using a learning algorithm. The learning server 121 calculates the learning data set, generated in step S1103, with a convolutional neural network.

In step S1105, the learning server 121 generates a learning model. The learning server 121 extracts a result of the calculation performed in step S1104, and stores the learning model data as a learning model candidate in the data storage unit 402.

In step S1106, the learning server 121 measures an estimation accuracy. The learning server 121 verifies the accuracy of a learning model stored in step S1105 with use of the previously collected data. In verification, the learning server 121 measures the accuracy with use of a method of using, for verification, data which is not being used for learning, such as a holdout method, and then stores information about the measured accuracy in the data storage unit 402.

In step S1107, the learning server 121 checks whether the accuracy has increased. The learning server 121 checks whether the accuracy measured this time in step S1106 has increased relative to the accuracy of the previously generated learning model. If it is determined that the accuracy has increased (YES in step S1107), the learning server 121 advances the processing to step S1108, and, if it is determined that the accuracy has not increased (NO in step S1107), the learning server 121 ends the processing in the present flowchart. While, in the first exemplary embodiment, the estimation is uniformly determined as processing to be performed by a program, actually, for example, the accuracy for a specific usage environment may increase but the accuracy for the other usage environments may decrease, so that it may be difficult to uniformly perform mechanical determination as to which of the performances is better. In consideration of such a case, checking of the accuracy can be performed as a result of human comparing investigation to be performed at each appropriate time, and the result can be input as an instruction to the learning server 121.

In step S1108, the learning server 121 performs updating of the learning model. The learning server 121 overwrites the learning model stored in the data storage unit 402 with the learning model candidate stored in step S1105.

The processing in the above-described flowchart enables generating a learning model for performing estimation processing, based on the collected learning data. The thus-generated learning model is preliminarily allocated to the data storage unit 302 of the MFP 100, and is, therefore, able to be used for the estimation processing unit 312 of the MFP 100 to perform estimation processing. While this learning model is preliminarily allocated at the time of equipment shipment, a mechanism for firmware version upgrade can be provided to enable performing updating of the learning model in time with updating of another program.

With the processing in the above-described flowchart, the MFP acquires an estimation result and presents the estimation result to the user, thus being able to assist the user to perform settings.

Furthermore, while an image forming apparatus has been described as an example, the present technique can be generally applied to information processing apparatuses including an image forming apparatus.

The processing in the above-described flowchart enables a user who does not have expert knowledge about security to select settings which are highly likely to be appropriate as a usage environment, regardless of the largeness or smallness of the communication volume.

Next, a second exemplary embodiment of the present disclosure is described based on the accompanying drawings. The second exemplary embodiment is an embodiment which, in a case where an environment which is currently selected by recommended security setting and a usage environment estimation result differ from each other, strongly recommends the user to change the settings.

The second exemplary embodiment has configurations similar to those in the first exemplary embodiment illustrated in FIG. 1, FIG. 2, FIG. 3, FIG. 4, FIG. 5, FIG. 7, FIG. 8, FIG. 9, and FIG. 10.

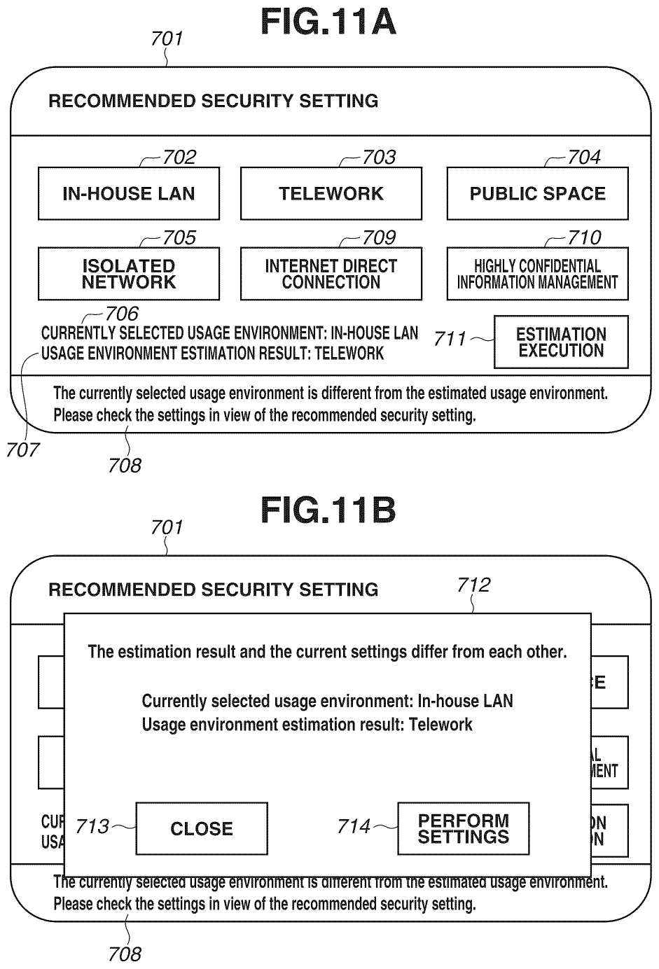

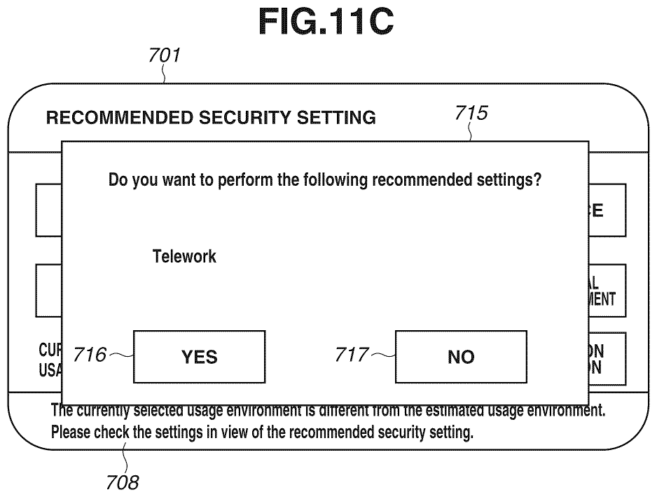

FIG. 11A illustrates a recommended security setting screen 701, which is displayed on the operation unit 102. The operation control unit 301 performs displaying control of the recommended security setting screen 701. Elements 701, 702, 703, 704, 705, 706, 707, 708, 709, and 710 illustrated in FIG. 11A are similar to those illustrated in FIG. 6.

An estimation execution button 711 is a button operable by the user to issue an instruction for starting estimation processing for a usage environment. As described above with reference to FIG. 9, the estimation processing is automatically performed at the time of completion of initialization of the network function or at the time of displaying of the recommended security setting screen 701 without the user issuing an instruction.

The estimation execution button 711 is used for the user to manually start performing estimation processing at optional timing.

FIG. 11B illustrates a recommended security setting screen 701 in which, in a case where a currently selected usage environment and a usage environment estimation result differ from each other, a pop-up screen 712 for informing the user to that effect has been displayed.

If the previously estimated usage environment estimation result and a currently selected usage environment differ from each other at the time of displaying of the recommended security setting screen 701, the recommended security setting screen 701 is displayed prior to displaying of the screen illustrated in FIG. 11A. In a case where the estimation result is updated during displaying of the screen illustrated FIG. 11A in response to pressing of the estimation execution button 711 or the completion of network initialization and the updated estimation result has become different from the currently selected usage environment, the screen illustrated in FIG. 11B is displayed at that timing. The pop-up screen 712 displays a message indicating that the currently selected usage environment and the usage environment estimation result differ from each other, the currently selected usage environment, and the usage environment estimation result. A close button 713 is a button, which is to be pressed by the user having determined that changing of the settings is unnecessary, and the pop-up screen 712 is hidden in response to pressing of the close button 713. A “perform settings” button 714 is a button, which is to be pressed by the user having determined that changing of the settings is necessary, and the pop-up screen 712 is switched to pop-up displaying illustrated in FIG. 11C.

FIG. 11C illustrates a recommended security setting screen 701 in which a pop-up screen 715 for inquiring of the user whether to allow displaying of recommended settings has been displayed. The pop-up screen 715 displays a usage environment estimation result indicative of recommended settings to be set now. A yes button 716 is a button operable to perform settings, and settings are performed in response to pressing of the yes button 716. A no button 717 is a button operable to stop performing settings, and the pop-up screen 715 is hidden in response to pressing of the no button 717.

In the above-described way, in a case where the usage environment which is currently selected in the recommended security setting screen 701 differs from a usage environment estimation result, the operation control unit 301 performs display control to display a pop-up screen including a usage environment indicated by the estimation result.

With the above-described configuration employed, the user is strongly recommended to use a usage environment estimation result, and thus becomes highly likely to use more favorable settings.

Next, a third exemplary embodiment of the present disclosure is described based on the accompanying drawings. The third exemplary embodiment is an embodiment which, in estimation of a usage environment, preferentially performs determination using some rules.

The third exemplary embodiment has configurations similar to those in the first exemplary embodiment illustrated in FIG. 1, FIG. 2, FIG. 3, FIG. 4, FIG. 5, FIG. 6, FIG. 7, FIG. 8, and FIG. 10. Moreover, as with the second exemplary embodiment, instead of the configuration illustrated in FIG. 6, the configuration illustrated in FIGS. 11A to 11C can be used.

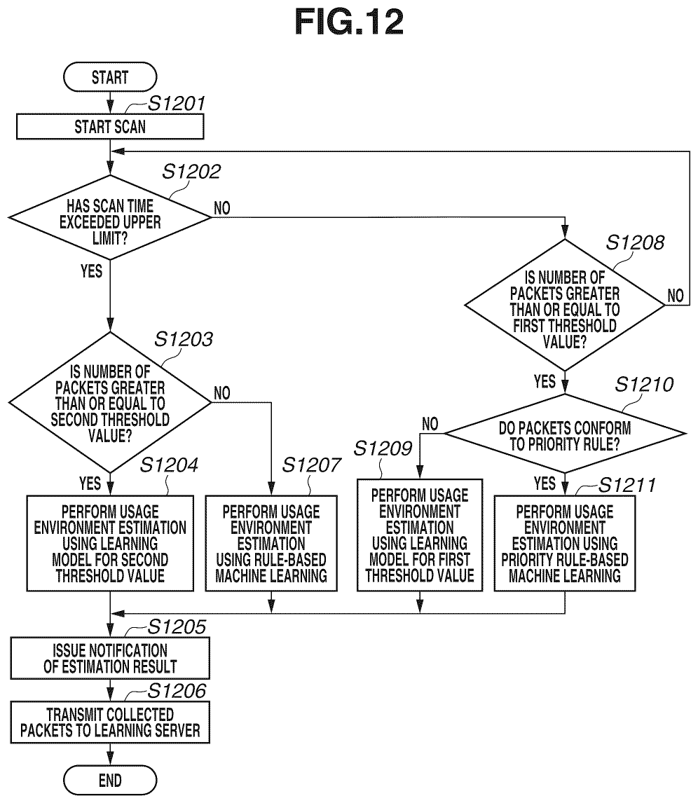

Processing which the MFP 100 performs to perform estimation processing, notify the user of a result of the estimation processing, and perform information transmission to a learning server directed to a future accuracy increase is described with reference to FIG. 12. The processing which the MFP 100 performs illustrated in FIG. 12 includes processing operations which are performed by the communication log extraction unit 311, the estimation processing unit 312, the operation control unit 301, and the learning server communication unit 310. The processing which the MFP 100 performs illustrated in FIG. 12 is implemented, as arithmetic processing which the CPU 201 performs, by the CPU 201 reading out a program stored in the flash ROM 211 onto the DRAM 202 and executing the program.

The processing in the flowchart of FIG. 12 is started at the time of completion of initialization of the network function or at the time of displaying of the recommended security setting screen 701 in the MFP 100. The initialization of the network function is performed, for example, at the time of system start-up after powering-on of equipment or at the time of changing of the network setting and is timing at which the MFP 100 becomes able to perform communication.

In step S1201, the MFP 100 starts scan. Specifically, the communication log extraction unit 311 captures network packets which are transmitted and received between the MFP 100 and the LAN 110.

In step S1202, the communication log extraction unit 311 checks whether the scan time has exceeded an upper limit thereof. Thus, the communication log extraction unit 311 checks whether a predetermined time has elapsed after starting scan of network packets. In the third exemplary embodiment, the upper limit of the scan time is assumed to be 60 seconds. This is preliminarily determined as a time for which network packets corresponding to a first threshold value, which is checked in step S1208, are able to be collected in many network environments. If it is determined that the scan time has exceeded the upper limit (YES in step S1202), the communication log extraction unit 311 advances the processing to step S1203, and, if it is determined that the scan time has not yet exceeded the upper limit (NO in step S1202), the communication log extraction unit 311 advances the processing to step S1208.

In step S1208, the communication log extraction unit 311 checks whether the number of packets is greater than or equal to the first threshold value.

Thus, the communication log extraction unit 311 checks whether the number of packets acquired within a predetermined time from the start of scan of network packets is greater than or equal to the first threshold value. In the third exemplary embodiment, the first threshold value is assumed to be 150 packets. This is preliminarily determined by verifying improved characteristics of the estimation accuracy relative to an increase in the number of input packets with respect to a usage environment estimation model and finding a branch point at which the proportion of an accuracy increase to an increase in the number of packets slows down. While, in terms of the estimation accuracy, it is favorable that the number of packets supposed to be inputs is greater, in terms of the estimation result displaying function, it is favorable that the scan time which depends on the number of packets is smaller. Moreover, it is known that, usually, the rate of progress of the estimation accuracy to the number of pieces of data supposed to be inputs becomes a logarithmic increase graph which slows down along with an increase in the number of pieces of data. If it is determined that the number of acquired packets is greater than or equal to the first threshold value (YES in step S1208), the communication log extraction unit 311 advances the processing to step S1210. If it is determined that the number of acquired packets is neither greater than nor equal to the first threshold value, i.e., is less than the first threshold value (NO in step S1208), the communication log extraction unit 311 returns the processing to step S1202. In a case where the number of acquired packets is neither greater than nor equal to the first threshold value, a small amount of processing stop time can be provided to avoid an excessive repetitive arithmetic operation.

In step S1210, the estimation processing unit 312 checks whether the packets conform to a priority rule. The priority rule is a rule high in degree of certainty such as a rule which, if, for example, IPSec packets are included, uniformly estimates that the usage environment is a highly confidential information management environment. In a case where such a rule high in degree of certainty is known in advance, performing this checking prior to performing estimation using a learning model enables increasing the accuracy of estimation. If, in step S1210, it is determined that the packets conform to the priority rule (YES in step S1210), the estimation processing unit 312 advances the processing to step S1211, and, if it is determined that the packets do not conform to the priority rule (NO in step S1210), the estimation processing unit 312 advances the processing to step S1209.

In step S1211, the estimation processing unit 312 performs usage environment estimation using priority rule-based machine learning. Thus, the estimation processing unit 312 performs preliminarily set estimation such as, if IPSec packets are included, uniformly estimating that the usage environment is a highly confidential information management environment.

In step S1209, the estimation processing unit 312 performs usage environment estimation using a learning model for the first threshold value. While the first threshold value is assumed to be 150 packets, the learning model for the first threshold value is a learning model for which data with 150 packets is prepared as each of data sets usable as learning data at the time of learning and which is optimized for inputting of 150 packets. Since this step is performed only in a case where 150 packets have been able to be acquired, these acquired packets are used as inputs for the estimation processing. Specifically, the estimation processing unit 312 extracts feature quantities such as those shown in Table 2 with use of 150 packets out of the packets which the communication log extraction unit 311 has been able to acquire within the predetermined time. The estimation processing unit 312 inputs the feature quantities which the communication log extraction unit 311 has extracted to the learning model for the first threshold value, and thus estimates a usage environment.

In step S1203, the communication log extraction unit 311 checks whether the number of packets is greater than or equal to a second threshold value.

In the third exemplary embodiment, the second threshold value is assumed to be 50 packets. This is preliminarily determined by verifying improved characteristics of the estimation accuracy relative to an increase in the number of input packets with respect to a usage environment estimation model and finding a lower limit value available for obtaining a significant estimation result. If it is determined that the number of acquired packets is greater than or equal to the second threshold value (YES in step S1203), the communication log extraction unit 311 advances the processing to step S1204. If it is determined that the number of acquired packets is neither greater than nor equal to the second threshold value, i.e., is less than the second threshold value (NO in step S1203), the communication log extraction unit 311 advances the processing to step S1207.

In step S1204, the estimation processing unit 312 performs usage environment estimation using a learning model for the second threshold value. While the second threshold value is assumed to be 50 packets, the learning model for the second threshold value is a learning model for which data with 50 packets is prepared as each of data sets usable as learning data at the time of learning and which is optimized for inputting of 50 packets. While there is a case where, in this step, 51 or more packets are acquired, only 50 packets in the order of being received are used as inputs for estimation processing. Specifically, the communication log extraction unit 311 extracts feature quantities such as those shown in Table 2 with use of 50 packets out of the packets which the communication log extraction unit 311 has been able to acquire within the predetermined time. The estimation processing unit 312 inputs the feature quantities which the communication log extraction unit 311 has extracted to the learning model for the second threshold value, and thus estimates a usage environment.

In step S1207, the estimation processing unit 312 performs usage environment estimation using rule-based machine learning. The estimation using rule-based machine learning is, for example, an estimation such as mentioned below. If a global IP address packet is included, the usage environment is uniformly estimated as an Internet direct connection environment. If such a condition is not met, the usage environment is estimated as an in-house intranet environment. The estimation using rule-based machine learning is such a decision table-based estimation. While this is lower in accuracy than the case using a learning model, there are many cases where this is better than the situation in which an estimation result is not able to be output due to the nature of the function.

In step S1205, the MFP 100 issues a notification of the estimation result. Specifically, the operation control unit 301 issues a notification of the estimation result. When being displaying the recommended security setting screen 701, the operation control unit 301 displays a usage environment estimated in any one of step S1204, step S1207, step S1209, and step S1211 at the usage environment estimation result 707. At this timing, the operation control unit 301 can transmit the estimation result to a management tool to display the estimation result on a display unit of the management tool, or can record the estimation result as a log in the MFP 100.

In step S1206, the MFP 100 transmits the collected packets to the learning server 121. Specifically, the learning server communication unit 310 transmits the collected packets to the learning server 121.

The processing in the above-described flowchart enables preferentially performing determination using some rules.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the functions of the above-described exemplary embodiments can also be implemented by a circuit which implements one or more functions of the above-described exemplary embodiments (for example, an application specific integrated circuit (ASIC) or a field-programmable gate array (FPGA)).

According to an information processing apparatus in aspects of the present disclosure, it is possible to selectively use separate models based on the number of acquired packets and thus appropriately estimate a usage environment of the information processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-044105 filed Mar. 19, 2024 and Japanese Patent Application No. 2024-094110 filed Jun. 11, 2024, which are hereby incorporated by reference herein in their entirety.

What is claimed is:

1. An information processing apparatus comprising:
at least one memory that stores a program; and
at least one processor that, upon execution of the stored program, is caused to:
acquire a plurality of packets that includes packets transmitted to the information processing apparatus and packets received by the information processing apparatus;
perform estimation of a usage environment of the information processing apparatus by inputting data that indicates a feature of the acquired plurality of packets to a model; and
display a result of the estimation,
wherein, when the number of the acquired plurality of packets is greater than or equal to a threshold value, the estimation is performed by inputting data that indicates a feature of the acquired plurality of packets to a first model, and
wherein, when the number of the acquired plurality of packets is less than the threshold value, the estimation is performed by inputting data that indicates a feature of the acquired plurality of packets to a second model different from the first model.

2. The information processing apparatus according to claim 1, wherein the at least one processor further executes the program to set a setting value corresponding to the estimated usage environment to the information processing apparatus.

3. The information processing apparatus according to claim 1,
wherein the plurality of packets is acquired within a predetermined time,
wherein, when the number of the plurality of packets acquired within the predetermined time is greater than or equal to the threshold value, the estimation is performed by inputting data that is based on the plurality of packets acquired within the predetermined time to the first model, and
wherein, when the number of the plurality of packets acquired within the predetermined time is less than the threshold value, the estimation is performed by inputting data that is based on the plurality of packets acquired within the predetermined time to the second model.

4. The information processing apparatus according to claim 1,
wherein the threshold value is a first threshold value;
wherein, when the number of the acquired plurality of packets is less than the first threshold value and is greater than or equal to a second, different threshold value lower than the first threshold value, the estimation is performed by inputting data that is based on the acquired plurality of packets to the second model, and
wherein, when the number of the acquired plurality of packets is less than the second different threshold value, the estimation is performed based on the acquired plurality of packets without using any of the first model and the second model.

5. The information processing apparatus according to claim 1, wherein the first model is generated by performing learning using, as learning data, data that indicates a feature of a plurality of packets the number of which corresponds to the threshold value.

6. The information processing apparatus according to claim 4, wherein the second model is generated by performing learning using, as learning data, data that indicates a feature of a plurality of packets the number of which corresponds to the second different threshold value.

7. The information processing apparatus according to claim 1, wherein the usage environment to be estimated is one or more of an environment connected to an in-house local area network (LAN), an environment connected directly to the Internet, an environment isolated from connection to the Internet, an environment supposed to be used for telework, an environment supposed to be used in a public space, and an environment for managing highly confidential information.

8. The information processing apparatus according to claim 1,
wherein the information processing apparatus is equipped with a scanner and a printer, and
wherein the plurality of packets to be acquired includes packets concerning a job which is executed by the scanner or the printer.

9. The information processing apparatus according to claim 1,
wherein when the number of the acquired plurality of packets is greater than or equal to the threshold value and the acquired plurality of packets satisfies a predetermined condition, a usage environment corresponding to the predetermined condition is output as a result of the estimation, and
wherein, when the number of the acquired plurality of packets is greater than or equal to the threshold value and the acquired plurality of packets does not satisfy the predetermined condition, the estimation is performed by inputting data that is based on the acquired plurality of packets to the first model.

10. The information processing apparatus according to claim 1,
wherein execution of the stored program further configures the at least one processor to:
perform control to display, on a display device, a screen for receiving selection of a usage environment of the information processing apparatus; and
set, in the information processing apparatus, a setting value corresponding to the usage environment selected in the screen, and
wherein, when the usage environment which has been selected and the setting value set to the information processing apparatus differs from a usage environment obtained as a result of the estimation, causing display of a pop-up screen including the usage environment obtained as a result of the estimation.

11. A control method for an information processing apparatus, the control method comprising:
acquiring a plurality of packets that includes packets transmitted to the information processing apparatus and packets received by the information processing apparatus;
performing estimation of a usage environment of the information processing apparatus by inputting data that indicates a feature of the acquired plurality of packets to a model; and
displaying a result of the estimation,
wherein, when the number of the acquired plurality of packets is greater than or equal to a threshold value, the estimation is performed by inputting data that indicates a feature of the acquired plurality of packets to a first model, and
wherein, when the number of the acquired plurality of packets is less than the threshold value, the estimation is performed by inputting data that indicates a feature of the acquired plurality of packets to a second model different from the first model.

12. A non-transitory computer-readable storage medium storing a computer program that, when executed by a computer, causes the computer to perform a control method for an information processing apparatus, the control method comprising:
acquiring a plurality of packets that includes packets transmitted to the information processing apparatus and packets received by the information processing apparatus;
performing estimation of a usage environment of the information processing apparatus by inputting data that indicates a feature of the acquired plurality of packets to a model; and
displaying a result of the estimation,
wherein, when the number of the acquired plurality of packets is greater than or equal to a threshold value, the estimation is performed by inputting data that indicates a feature of the acquired plurality of packets to a first model, and
wherein, when the number of the acquired plurality of packets is less than the threshold value, the estimation is performed by inputting data that indicates a feature of the acquired plurality of packets to a second model different from the first model.
